(19) United States
(12) Patent Application Publication
(10) Pub. No.: US 2022/0303227 A1
(43) Pub. Date: Sep. 22, 2022

(54) FACILITATING IDENTIFICATION OF BACKGROUND BROWSING TRAFFIC IN BROWSING HISTORY DATA IN ADVANCED NETWORKS

(71) Applicant: AT&T Intellectual Property I, L.P., Atlanta, GA (US)

(72) Inventors: Zhengyi Zhou, Chappaqua, NY (US); Deirdre Paul, Morristown, NJ (US); Christopher Volinsky, Morristown, NJ (US)

(21) Appl. No.: 17/204,746

(22) Filed: Mar. 17, 2021

(51) Int. Cl. H04L 12/927; H04L 12/911; H04W 72/12

(52) U.S. Cl. CPC H04L 47/805; H04L 47/821; H04L 47/801; H04W 72/1242

(57) ABSTRACT

Facilitating identification of background browsing traffic in browsing history data in advanced networks (e.g., 5G, 6G, and beyond) is provided herein. Operations of a system can include, based on browsing history traffic observed with respect to a group of user equipment, constructing labeling functions for a group of domains associated with the browsing history traffic, producing a group of labels based on the labeling functions, and transforming the group of labels into a single consolidated label for a first domain. Further, the operations can include, based on a determination that a first numeric value of the single consolidated label is nearer to a first value than a second value, scheduling first traffic for the first domain prior to scheduling traffic for a second domain determined to include the second numeric value that is nearer the second value than the first value.

### TECHNICAL FIELD

This disclosure relates generally to the field of network communication and, more specifically, to mining browsing history data to identify background traffic for various purposes in wireless communication systems for advanced networks (e.g., 5G, 6G, and beyond).

### BACKGROUND

Internet usage, especially through user equipment, has been significantly increasing. A vast amount of data related to the internet usage is available and can be utilized to learn information about when users are actively engaging with the network traffic, which can be used to manage and prioritize network resources. Therefore, unique challenges exist to provide levels of service and relevant information associated with the network traffic in order to effectively manage and prioritize the network resources.

### BRIEF DESCRIPTION OF THE DRAWINGS

Various non-limiting embodiments are further described with reference to the accompanying drawings in which:

FIG. 1 illustrates an example, non-limiting, computer-implemented method for separating foreground browsing traffic from background browsing traffic in accordance with one or more embodiments described herein;

FIG. 2 illustrates an example, non-limiting, computer-implemented method for constructing label functions in accordance with one or more embodiments described herein;

FIG. 3 illustrates an example, non-limiting, computer-implemented method for consolidating the constructed label functions in accordance with one or more embodiments described herein;

FIG. 4 illustrates an example, non-limiting, computer-implemented method for optionally building a machine learning model in accordance with one or more embodiments described herein;

FIG. 5 illustrates an example, non-limiting, computer-implemented method that facilitates identification of background browsing traffic in user browsing history data in advanced networks in accordance with one or more embodiments described herein;

FIG. 6 illustrates an example, non-limiting, computer-implemented method that facilitates determining status of traffic as background traffic or foreground traffic based on information centered on a screen on and/or off indicator in accordance with one or more embodiments described herein;

FIG. 7 illustrates an example, non-limiting, computer-implemented method that builds a machine learning model based on labels consolidated from constructed label functions in accordance with one or more embodiments described herein;

FIG. 8 illustrates an example, non-limiting, system that facilitates identification of background browsing traffic in user browsing history data in advanced networks in accordance with one or more embodiments described herein;

FIG. 9 illustrates an example, non-limiting, block diagram of a handset operable to engage in a system architecture that facilitates wireless communications according to one or more embodiments described herein; and

FIG. 10 illustrates an example, non-limiting, block diagram of a computer operable to engage in a system architecture that facilitates wireless communications according to one or more embodiments described herein.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details (and without applying to any particular networked environment or standard).

Described herein are systems, methods, articles of manufacture, and other embodiments or implementations that can facilitate identifying background browsing traffic in browser history data. Foreground browsing traffic in the browser history data can also be identified. As used herein, background browsing traffic (also referred to as background traffic or, more simply, background) relates to browsing traffic for which a user is not actively engaged with a device (e.g., a user equipment (UE)). Further, as used herein, foreground browsing traffic (also referred to as foreground traffic or, more simply, foreground) relates to browsing traffic for which a user is actively engaged with the device.

The various embodiments provide for the identification of background browsing traffic, which occurs while the user is not actively engaged with the device (e.g., UE). Examples of background browsing traffic include, but are not limited to, operating system requests, applications (apps) maintenance, utility requests, and so on. This identification can facilitate the management of browsing demand. For example, foreground traffic can be prioritized while background traffic can be de-prioritized, which can be accomplished without sacrificing perceived quality in user experience (also referred to as service experience).

Further, one or more of the various embodiments described herein provide an effective way to identify background traffic from browsing history data without implicating user-side access, extensive annotation, and/or testing. Signals from multiple sources (e.g., observed nature of the traffic, characteristics of the traffic, information related to the timing of the traffic, information related to a domain associated with the traffic, external sources, and underlying patterns of the signals) can be aggregated. The signals can be combined intelligently into a single strong signal. Based at least in part on this single strong signal, learning models with additional signals can be developed to further improve accuracy. Additionally, a label consolidation and learning model can provide insights into the nature of background traffic (e.g., relative reliability of various signals and different signatures of the background traffic). The label consolidation and learning model can facilitate segmentation and ranking of background traffic for customized and prioritized management by providing accuracy and confidence measures of how likely traffic is to be background, and providing insight into the different types, signatures, or segments to which the background traffic belongs. The various embodiments are easy to customize, update, and interpret. Further, the ability to detect and separate background traffic from foreground traffic can be utilized to improve (e.g., optimize) network management.

It has been estimated that background traffic constitutes about one-third to two-fifths of total wireless traffic. Further, it has been found that traffic occurring when a screen is “off” accounts for 58.5% of the total radio energy consumption, although the volume of such traffic is much smaller. These findings provide evidence of the potential savings that can be realized by better (e.g., optimally) managing background traffic.

Generally, background traffic occurs when the UE screen is dark, with several notable exceptions. An exception is when a user is listening to audio or video while the screen is dark. Since the user is actively engaged by listening, such traffic is in fact foreground traffic and should not be delayed. In contrast, traffic that occurs when the UE screen is on standby (no user input) before dimming to screen off is actually background traffic since the user is not engaged with the UE during that period of time. Another example of background traffic includes passive system requests, where operating systems or apps generate traffic for maintenance, utility, and/or update purposes. Still another example of background traffic is a large content download (or a large content upload) for which the user is not actively waiting. Some types of background traffic (e.g., system, maintenance, and automated requests) tend to occur with regular periodicity, while other types of background traffic do not occur with regular periodicity. The disclosed embodiments can identify such background traffic from aggregated user browsing history log data, without direct/empirical evidence and without user-side access.

Two conventional lines of study have been identified. A first conventional line of study has proposed to use a screen on and/or off indicator to differentiate foreground traffic from background traffic. A second conventional line of study detects periodicity in traffic and categorizes periodic traffic as background traffic. Challenges associated with these two lines of study will now be discussed.

The first conventional line of study, which proposes to use the screen on and/or off indicator to differentiate foreground and background traffic, would require user-side access and permission, which is typically not available and for which it is intrusive to ask, especially at scale. Screen on and off is also not an imperfect indicator of foreground or background traffic when exceptions are considered, as mentioned above. Relying solely on the screen on and off indicator becomes increasingly weak as a differentiator as the demand for background services increases. Examples of such background services include, but are not limited to, UE tethering, off-screen audio and/or video streaming (e.g., Spotify®, YouTube®, Stitcher®, Netflix®, Hulu®, and so on), off-screen call or conference (e.g., Skype®, Zoom®, and so on), or voice activated devices or services (e.g., Siri®, Google Assistant®, Alexa®, connected cars, and so forth).

The second conventional line of study, which detects periodicity in traffic and categorizes periodic traffic as background, acknowledges that non-periodic background flows typically cannot be detected. Operating systems and apps can be designed to include non-periodic background requests in order to circumvent being identified as background traffic. Further, traffic to some domains is a mixture of periodic background traffic and random foreground traffic, making periodicity difficult to detect. Some background traffic is also, by nature, not periodic, such as, for example, off-screen downloads, which usually incur a large amount of upload and/or download bytes and have larger impact when de-prioritized as compared to small-byte periodic pinging and/or pinging.

These conventional solutions may work well for some subsets of traffic, but are not robust to all traffic. In contrast, one or more of the various embodiments provided herein intelligently combine signals from multiple sources into a single strong signal in order to categorize the traffic. According to an optional embodiment, learning models can be developed to further improve accuracy as will be discussed in further detail below.

Example embodiments provided herein identify cellular browsing traffic that occurs in the background and separate the background browsing traffic from foreground browsing traffic. Foreground browsing traffic is generated by the user while the user is actively engaged with the UE. Such active engagement can include, for example, browsing webpages, checking emails, actively using applications executing on the UE (e.g., apps), listening to audio, watching videos, playing online games, and so forth. Background traffic is generated while the user is not actively engaged with the UE. Background traffic can be de-prioritized with slight delays in connection and delivery, without sacrificing perceived quality in user experience. This selective de-prioritization can allow telecommunication companies to prioritize foreground requests given limited resources and exploding browsing demand.

In one embodiment, described herein is a method that includes defining, by network equipment including a processor, a group of labeling functions for a group of domains associated with observed browsing traffic. The method also includes consolidating, by the network equipment, a first group of labels, produced by the group of labeling functions, into a first consolidated label for a first domain of the group of domains, and a second group of labels, produced by the group of labeling functions, into a second consolidated label for a second domain of the group of domains. The first consolidated label and the second consolidated label each lie on a continuum between a first value indicative of the observed browsing traffic being foreground traffic and a second value indicative of the observed browsing traffic being background traffic. The method also includes, based on a first determination that the first domain is associated with the foreground traffic and a second determination that the second domain is associated with the background traffic, prioritizing, by the network equipment, first network traffic to the first domain prior to second network traffic for the second domain.

The foreground traffic can include first information related to first browsing behavior that resulted from input via a user interface to a browser. The background traffic can include second information related to second browsing behavior that did not result from the input.

The method also can include differentiating, by the network equipment, the foreground traffic from the background traffic based on the first consolidated label and the second consolidated label. Further, the method can include ranking, by the network equipment, the first domain and the second domain based on the first consolidated label and the second consolidated label. Additionally, the method can include determining, by the network equipment, that the observed browsing traffic, which satisfies a defined threshold value on the continuum between the first value and the second value, is the background traffic.

The defining can include constructing the group of labeling functions to satisfy a defined accuracy level. In some implementations, the defining can include constructing the group of labeling functions to satisfy a defined coverage level. In some implementations, the defining includes partitioning the group of domains into clusters based on an unsupervised learning based clustering analysis of the group of domains.

According to some implementations, the defining can include identifying activation of a display associated with a user equipment during at least part of the observed browsing traffic. Further to these implementations, the defining can include adjusting an indication associated with the activation of the display based on a type of activity associated with at least part of the observed browsing traffic. The adjusting can include, based on the display not being activated and the type of activity being a defined activity type, determining that at least part of the observed browsing traffic is the foreground traffic. Alternatively, the adjusting can include, based on the display being activated and the type of activity not being a defined activity type, determining that at least part of the observed browsing traffic is the background traffic.

In some implementations, the defining can include aggregating signals from multiple sources, resulting in aggregated signals. The signals can include respective information associated with the observed browsing traffic. Further, the defining can include training a model to distinguish the foreground traffic from the background traffic based on the aggregated signals. In an example, the respective information includes information related to a substring match of the observed browsing traffic.

In some examples, the respective information includes a first activity level of a user equipment for a first time period, and a second activity level of the user equipment for a second time period. Further to this example, the method includes, based on the first activity level satisfying a defined activity level, classifying, by the network equipment, first browsing traffic occurring during the first time period as the foreground traffic. The method also includes, based on the second activity level satisfying the defined activity level, classifying, by the network equipment, second browsing traffic occurring during the second time period as the background traffic.

In accordance with some examples, respective information includes a data structure including known domains. Further to these examples, the method includes mapping, by the network equipment, at least a subgroup of domains of the group of domains to the known domains. The method also includes, based on the mapping indicating the first domain matches a known domain of the known domains in the data structure, classifying, by the network equipment, the first domain as the foreground traffic.

According to one or more examples, the respective information can include a characteristic of the observed browsing traffic. The characteristic can include at least one characteristic from a group of characteristics, including: a periodicity of the observed browsing traffic, intervals of the observed browsing traffic, a first amount of upload bytes of the observed browsing traffic, a second about of download bytes of the observed browsing traffic, and a frequency of the observed browsing traffic.

Further, the respective information can include a data structure that includes a defined substring and the method can include matching, by the network equipment, a subgroup of substrings associated with a portion of the observed browsing traffic to the defined substrings. Further, the method can include, based on the matching indicating the subgroup of substrings matches the defined substring of the substrings, classifying, by the network equipment, the portion of the observed browsing traffic as background traffic.

Another embodiment relates to a system that can include a processor and a memory that stores executable instructions that, when executed by the processor, facilitate performance of operations. The operations can include, based on browsing history traffic observed with respect to a group of user equipment, constructing labeling functions for a group of domains associated with the browsing history traffic. Further, the operations can include producing a group of labels based on the labeling functions, wherein the group of labels are associated with a first domain of the group of domains. The operations also can include transforming the group of labels into a single consolidated label for the first domain. The single consolidated label is represented as a first numeric value that is on a continuum between two values. The two values include a first value and a second value. The first value is indicative of the browsing history traffic being foreground traffic and the second value is indicative of the browsing history traffic being background traffic. Further, the operations can include, based on a determination that the first numeric value of the single consolidated label is nearer to the first value than the second value, scheduling first traffic for the first domain prior to scheduling traffic for a second domain determined to include a second numeric value that is nearer the second value than the first value.

According to some implementations, the first value is 0 and the second value is 1. The foreground traffic can include first information related to first browsing behavior that is based on user input. The background traffic can include second information related to second browsing behavior that is not based on the user input.

The operations can include, in some implementations, identifying domains of the group of domains that are associated with audio streaming, conference functions, or voice activated services, resulting in identified domains. Further, the operations can include labeling traffic determined to be associated with the identified domains as the foreground traffic.

In some implementations, the operations can include identifying domains of the group of domains that are associated with defined substrings, resulting in identified domains. Further, the operations can include labeling traffic determined to be associated with the identified domains as the background traffic.

A further embodiment relates to a non-transitory machine-readable medium, including executable instructions that, when executed by a processor, facilitate performance of operations. The operations can include generating, based on a group of labeling functions established for domains accessed during a defined period of time and associated with observed browsing traffic, a first group of labels for a first domain of the domains and a second group of labels for a second domain of the domains. Further, the operations can include consolidating the first group of labels into a first label for the first domain, and the second group of labels into a second label for the second domain. The first label and the second label each fall on a continuum between a first state and a second state. The first state is indicative of the observed browsing traffic being foreground traffic. The second state is indicative of the observed browsing traffic being background traffic. The operations also can include, based on first network traffic, determined to be intended for the first domain, being classified as the foreground traffic, increasing a first priority for scheduling the first network traffic. Further, based on second network traffic, determined to be intended for the second domain, being classified as the background traffic, the operations can include reducing a second priority for scheduling the second network traffic to be less than the first priority.

In some implementations, the foreground traffic includes information related to user-engaged browsing behavior. The background traffic includes background activity void of the information related to the user-engaged browsing behavior.

According to some implementations, the operations can include detecting activation of a display associated with a user equipment during the observed browsing traffic and adjusting an indication associated with the activation of the display based on a type of activity associated with the observed browsing traffic. The adjusting can include, based on the display not being activated and the type of activity being determined to be of a defined activity type, determining that the observed browsing traffic is the foreground traffic. Alternatively, the adjusting can include, based on the display being activated and the type of activity being determined not to be of the defined activity type, determining that the observed browsing traffic is the background traffic.

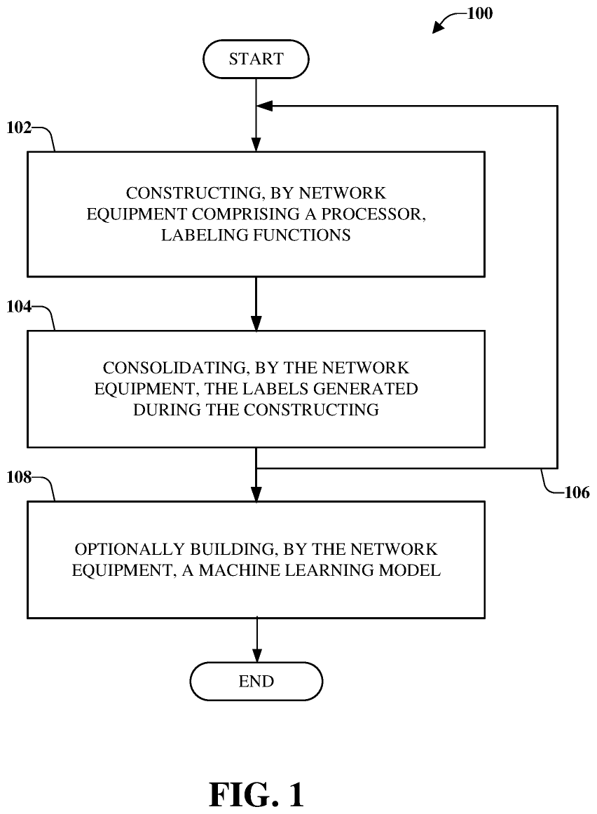

Referring initially to FIG. 1, illustrated is an example, non-limiting, computer-implemented method 100 for separating foreground browsing traffic from background browsing traffic in accordance with one or more embodiments described herein. The computer-implemented method 100 can be implemented by a system including a processor, network equipment including a processor, or another computer-implemented device including a processor.

The computer-implemented method 100 and other embodiments provide for an ensemble of procedures to label how likely requests to each domain happen in the background or in the foreground. These imperfect but largely correct labels are consolidated into a single strong set of labels. Thereafter, a supervised machine learning model can be optionally built with additional features to predict for domains with predominant background traffic more accurately.

At 102 of the computer-implemented method 100, labeling functions can be constructed. Requests to any given domain (e.g., example_domain.com) could be consistently background (e.g., operating system checking for updates), consistently foreground (e.g., user actively browsing a niche webpage), or a mixture of foreground and background (e.g., an app checks for updates every 5 minutes (or another time frame) in the background and, when the user refreshes, the app checks for updates in the foreground). A domain is labeled as primary foreground (0), primary background (1), or somewhere between 0 and 1 (where a label between 0 and 1 indicates a mixture of traffic and/or uncertainty). Through extensive testing, a number of labeling functions have been developed. Such labeling functions do not need to be perfect and foolproof labels, but should have threshold accuracy (e.g., correct more than 70% of the time) and threshold coverage (e.g., providing labels to more than 20% of the domains). Further, it is noted that use of a large number of labeling functions results in improved performance relative to use of a small number of labeling functions. Some labeling functions provided include, but are not limited to, screen on and/or off indicator; low activity time; corrections for: audio/video streaming, call/conference, personal digital assistant or voice activated services, and/or tethering; frequency and interval of appearances; other labels such as: substring, external lists, and/or the amount of upload/download bytes; and/or clustering memberships. Further details related to the labeling functions will be provided below.

At 104, the computer-implemented method 100 can consolidate the labels. As many of the labels generated at 102 as possible should be consolidated into a single set of labels. For example, the single set of labels can include first labels that match a first state (e.g., 0 or foreground), second labels that match a second state (e.g., 1 or background), and third labels that fall on a continuum between the first state and the second state. There are many ways to consolidate the labels including, but not limited to: mode (majority vote), average, and/or weighted average; a belief-propagation style iterative process; and/or a label consolidating process, such as, for example a Snorkel style label consolidator. (See, for example, https://www.snorkel.org/). Further details related to consolidating the labels will be provided below. It is noted that, as indicated by the feedback loop 106, constructing the labeling functions at 102 and consolidating the labels at 104 can be performed at various intervals to accommodate for changes in domain names.

Optionally, at 108 of the computer-implemented method 100, a machine learning model can be built. While the consolidated labels can be used to directly provide information as to how likely traffic to a given domain is background traffic, optionally and/or additionally, a machine learning model can be built to help learn the defining characteristics of background traffic, improve on prediction accuracy, and help predict for domains thus far unseen (e.g., brand new domains). The features used can include all features generated from the labeling functions, at 102. Additionally, the following types of features can be included: slightly weaker features; more granular features; and/or features whose correlation with background versus foreground traffic is unknown.

The labels used for generating the machine learning model can be the consolidated labels from 104. The model has a wide range of choices for feature engineering, supervised machine learning models (e.g., non-linear methods), and regularization. Thereafter, the machine learning model can be used to predict and generate, for all domains, the final labels of how likely a domain is background traffic versus foreground traffic.

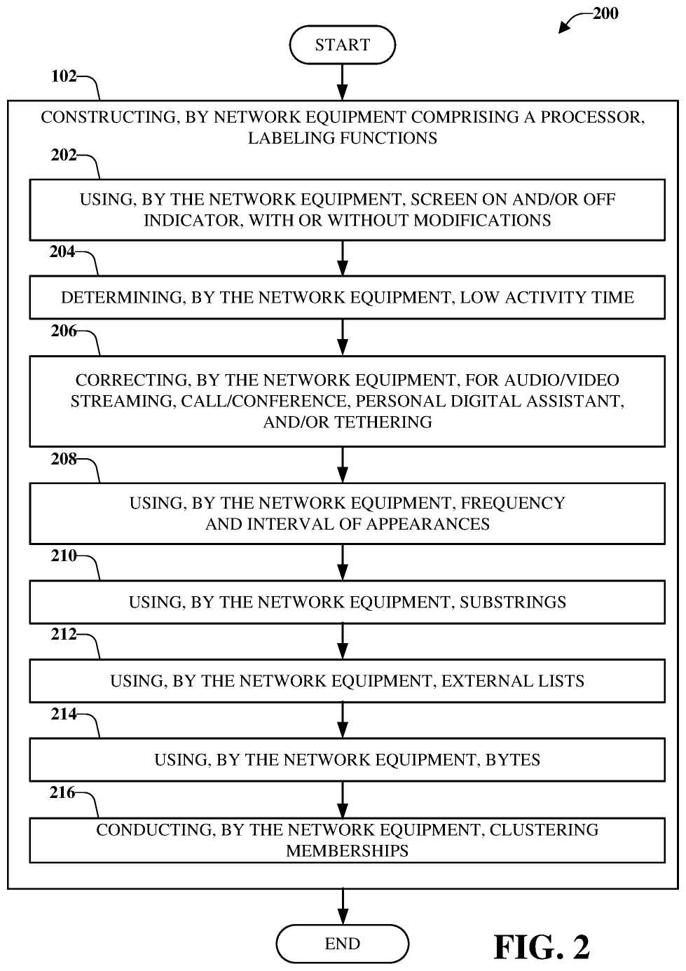

FIG. 2 illustrates an example, non-limiting, computer-implemented method 200 for constructing label functions in accordance with one or more embodiments described herein. The computer-implemented method 200 can be implemented by a system including a processor, network equipment including a processor, or another computer-implemented device including a processor.

Constructing the label functions according to FIG. 2 can be used, for example, to construct the label functions at 102 of FIG. 1. The elements discussed with respect to FIG. 2 (or a subset thereof) can be used individually or at the same time (or substantially the same time) as one another. As discussed above, the labeling functions do not need to be perfect or foolproof, but should have threshold accuracy, threshold coverage, and there should be a large number of labeling functions. According to non-limiting examples, threshold accuracy can be defined as being correct more than 70% of the time and threshold coverage can be defined as providing labels to more than 20% of the domains.

Input to the computer-implemented method 200 can be information from browsing history log data, for example. At 202, a labeling function can utilize information obtained from a screen on and/or off indicator with or without modifications. If the times of when the screens were turned on and/or off for a subset of the population are known (typically this is not known for all UEs), all traffic that occurred when the screens were on could be labeled as foreground, and the traffic that occurred while the screens were dark could be labeled as background. Based on this, labels can be consolidated across many request instances and across UEs to the domain level by, for example, taking the average. This should be correct for most cases, but exceptions and some potential remedies exist.

Some exceptions deal with streaming audio and/or video (e.g., Spotify®, YouTube®, and so forth), being on a call or conference (e.g., Skype®, Zoom®, and others), speech activated personal digital assistants or speech activated devices (e.g., Siri®, Google Assistant®, and so on), and/or enabling Wi-Fi hotspot for other UEs to tether while the screen is dark. Such activities might be labeled as background traffic by the labeling function, but should be labeled as foreground traffic. Additional labeling functions to remedy this will be discussed in further detail below.

Another exception deals with traffic that occurred when a UE has its screen on in standby mode before dimming to screen off. The period while in standby mode would be labeled as foreground traffic, but should be labeled as background traffic, since the user is not actively engaged with the UE during this time. As alternative or additional labeling functions, traffic occurring in the last few minutes of each screen-on episode, leading into a screen-off episode, can be labeled as uncertain or foreground traffic with reduced confidence.

Yet another exception deals with the UE clock time of screen on and/or off, whereas browsing traffic is recorded centrally in absolute time. There may be a difference between these two times if a UE does not synchronize its time automatically. There may also be a slight difference between the recorded and actual times of screen on and/or off, as well as between the recorded and actual times of browsing requests. Alternative and/or additional labeling functions include, for example, labeling traffic occurring around the boundary of screen-on and screen-off episodes with reduced confidence or as uncertain.

Given that typically only the screen on/off times are available for at most a subset of UEs, a well-represented sample of all browsing traffic might not be available due to biases in operating systems, apps installed, and so on. Further, there might not be any screen on/off times available for any UEs at all. Thus, to mitigate this unavailability, it can be beneficial and/or necessary to obtain labels from other sources.

At 204 of the computer-implemented method 200, low activity time can be determined. This determination can include labeling all traffic occurring at some pre-defined core nighttime hours (local time to UEs) as background traffic, assuming that most users are sleeping at these hours. Additionally, or alternatively, for each user, a few custom hours when the user consistently incurs the lowest upload and/or download bytes can be determined. All traffic occurring at these hours can be labeled as background traffic. Further, labels across request instances and across UEs can be consolidated to the domain level by, for example, taking an average of the labels.

Another labeling function can be based on corrections for audio/video streaming, call/conference, voice activated devices, and/or tethering, at 206 of the computer-implemented method 200. Thus, domains and content delivery networks of all major websites and apps for audio/video streaming, call/conference, and/or voice activated devices can be determined. Such domains and content delivery networks can be retained in a data store (e.g., in a list, in a searchable table, and so on). These domains can be labeled as foreground traffic. Additionally, or alternatively, if the browsing data has an indicator for tethering, all traffic that occurred when the indicator is on could be labeled as foreground traffic.

Yet another labeling function can be based on frequency and interval of appearances, at 208 of the computer-implemented method 200. It has been found that a large portion of background traffic (especially those corresponding to system and app pinning and refreshing, app pinging, location positioning, and so on) tends to appear at regular intervals consistently over time (e.g., once every hour and every day). In contrast, foreground traffic typically occurs as short spurts of a large number of requests (e.g., three different sessions a week, each lasting only for a few minutes, but having many requests). Based on this, a number of rule-based labeling functions can be designed. These rule-based labeling functions can include (1) whether the total number of times that a domain is requested satisfies a threshold number of times, (2) whether the proportion of days during which the domain is requested satisfies a threshold number of days, and (3) whether the proportion of hours a domain is requested satisfies a threshold number of hours. If one or more of these rules are true, the traffic to the domain can be labeled as background traffic. The thresholds can be set manually or empirically as percentiles. Multiple labeling functions could be constructed from different thresholds.

If the inter-arrival times between successive requests to a domain have a large median (or mean or mode) and a small interquartile range (or standard deviation), traffic to the domain could be labeled as background traffic. The thresholds can be set manually or empirically as percentiles. Multiple labeling functions could be constructed from different thresholds. Alternatively, or additionally, if traffic to a domain is periodic, periodicity analysis could be used to label traffic to this domain as background traffic.

At 210, a substring can be used as a labeling function. Some substrings, such as “connectivitycheck,” “appmeasurement,” “android,” “configuration.apple,” and so forth, can signify background traffic. A custom list of such substrings can be compiled. Based on this list, as a rule, domains with matching substrings can be labeled as background traffic.

External lists can be used, at 212, for the labeling function. For example, as another rule, domains appearing on third-party popular domain lists (e.g., Quantcast®, Alexa®, or others) can be labeled as foreground traffic.

Further, at 214 of the computer-implemented method 200, an amount of upload and/or download bytes can be used for the labeling function. Background system or app maintenance and utility-type traffic tends to have a smaller number of upload and/or download bytes as compared to most of foreground traffic. Thus, a label function can be designed based on the number of upload/download bytes satisfying a defined threshold byte level. Those that do not satisfy the defined threshold byte level (e.g., less than the defined threshold byte level) can be designated as background traffic and traffic that satisfies the defined threshold byte level (e.g., at or more than the defined threshold byte level) can be designated as foreground traffic. The threshold can be set manually or empirically as percentiles. Multiple labeling functions could be constructed from different thresholds.

At 216, clustering membership or embedding relationships can be used for the labeling function. From the labeling functions discussed above with respect to 202 through 214, not only are labels generated, but features, such as frequency of appearance or presence of a certain substring, are available. From these features, an unsupervised clustering analysis can be conducted to partition all domains into two or more clusters. All domains in the same cluster are given the same labels (foreground, background, or uncertain) from, for example, a majority vote of labels from labeling function categories as discussed with respect to 202 through 214. Further, multiple labeling functions can be constructed from the different number of clusters used. Alternatively, or additionally, a domain's label can be set by aggregating the labels of its nearest neighbors in the feature space or various embeddings of the feature space.

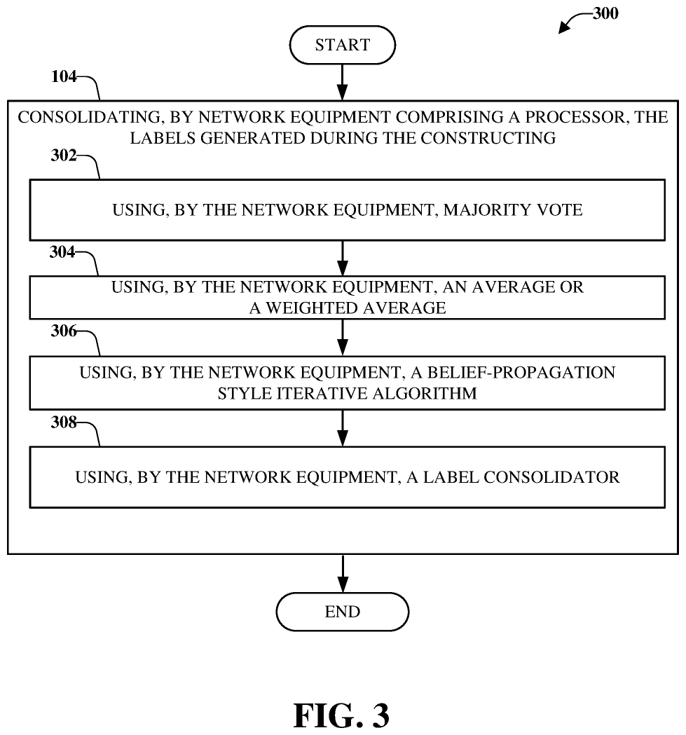

FIG. 3 illustrates an example, non-limiting, computer-implemented method 300 for consolidating the constructed label functions in accordance with one or more embodiments described herein. The computer-implemented method 300 can be implemented by a system including a processor, network equipment including a processor, or another computer-implemented device including a processor.

Consolidating the labels according to FIG. 3 can be used to consolidate the labels at 104 of FIG. 1. The elements discussed with respect to FIG. 3 (or a subset thereof) can be used individually or at the same time (or substantially the same time) as one another. The computer-implemented method 300 can consolidate the various labels generated from 102 of FIG. 1, or from FIG. 2, into a single set of labels. This single set of labels can include labels having respective values between 0 (representing foreground) and 1 (representing background). It is noted that instead, in some implementations, 0 can represent background and 1 can represent foreground.

Input to the computer-implemented method 300 can be an output from 102 of FIG. 1, or an output of the computer-implemented method 200 of FIG. 2. At 302, majority vote can be utilized to consolidate the labels and/or, at 304, an average or a weighted average can be utilized to consolidate or aggregate the labels. The uncertain labels can be treated as a category when majority vote is utilized. Alternatively, the uncertain labels can be treated as numeric values (representing how likely a domain is to be background versus foreground) when obtaining averages. Weighting of an average can be applied if prior knowledge of the reliability of the labels are known, or to reduce the overall impact of several highly correlated labels (e.g., labels obtained from different versions of screen on/off times, raw or with boundary treatment).

At 306, a belief-propagation style iterative process can be utilized. In this case, the computer-implemented method 300 could loop through iterations of two steps until convergence is achieved. A first step can be to obtain the consolidated labels by taking a weighted average of all labels, for example, weighted by each label's reliability scores (initialized as equal). For example, the initialization can be a value of 0.5 in a score that ranges between 0 and 1 such that the values are initialized at an equal value. The second step can be to obtain the reliability scores by comparing how well each label matches the consolidated label.

A label consolidating process can be utilized, at 308. For example, the label consolidating process can be a Snorkel style label consolidator or another type of weak supervision consolidator. Such a consolidator can detect and take into account correlations and other statistical dependencies among labeling functions.

Upon or after a single set of consolidated labels is determined (e.g., at 302, 304, and/or 306), the single set can be used to differentiate background from foreground browsing traffic. According to some implementations, the consolidated labels can be ranked numerically and domains with label values above an absolute or a relative cutoff can be deemed to be background traffic, or predominantly background traffic.

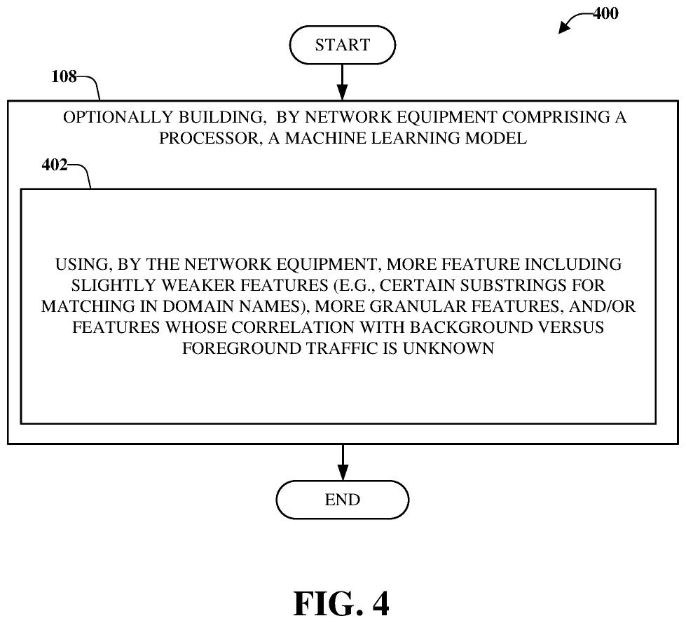

FIG. 4 illustrates an example, non-limiting, computer-implemented method 400 for optionally building a machine learning model in accordance with one or more embodiments described herein. The computer-implemented method 400 can be implemented by a system including a processor, network equipment including a processor, or another computer-implemented device including a processor.

Building the machine learning model according to FIG. 4 can be used to build the machine learning model at 108 of FIG. 1. The elements discussed with respect to FIG. 4 (or a subset thereof) can be used individually or at the same time (or at substantially the same time) as one another. The computer-implemented method 400 can build the machine learning model based on the consolidated labels to directly provide information as to how likely traffic to a given domain is to be background traffic. Thus, building the machine learning model is optional and can be built to help learn the defining characteristics of background traffic, improve on prediction accuracy, and help predict for domains thus far unseen.

Input to the computer-implemented method 400 can be an output from 104 of FIG. 1, or an output of the computer-implemented method 300 of FIG. 3. At 402, more features can be applied to build the model. The features used can include one or more of the features generated from the labeling functions as discussed with respect to 102 of FIG. 1 and the computer-implemented method 200 of FIG. 2.

Additionally, the following types of features can also be included: slightly weaker features; more granular features; and unknown features. Slightly weaker features can be features to which labels cannot be assigned with threshold accuracy and/or features for which it is unclear to which labels to assign with threshold accuracy (e.g., certain substrings for matching in domain names). The more granular features are features that may not provide labeling functions with acceptable coverage over the entire domain space (e.g., matching only the top 10% of the popular domain list, or matching every minute on the boundary of screen on/off times). The unknown features are those features whose correlation with background versus foreground traffic is unknown (e.g., features relating to the nature of the packets transmitted).

The labels used are the consolidated labels from 104 of FIG. 1 or the computer-implemented method 300 of FIG. 3. The model has a wide range of choices for feature engineering, supervised machine learning models (e.g., non-linear methods), and regularization. A prediction for all domains can be made to generate the final labels of how likely a domain is background versus foreground traffic.

As discussed herein, the various embodiments can effectively identify background traffic from browsing history data. Instead of relying on a single metric, such as screen on/off or periodicity, the disclosed embodiments aggregate signals from multiple sources. The multiple sources include, for example, observed nature of traffic (e.g., frequency, number of bytes utilized during upload and/or download, intervals, periodicity), information on the times of traffic (e.g., screen on/off, low-activity time, nighttime), information on the domain (e.g., substring match), external sources (e.g., domain popularity ranking), and/or underlying patterns in the myriad of signals (e.g., clustering membership).

These signals are intelligently combined into a single strong signal, and learning models can be developed with additional signals to further improve accuracy. The label consolidation and learning model training process provides a measure of accuracy or confidence as to how likely each traffic is to be background. The labeling consolidation and learning model training process also provides additional insight into the nature of the traffic (e.g., different types, signatures, or segments of background traffic, or relative reliability and importance of various signals, and so on). The disclosed embodiments can also further segment and rank traffic by confidence and nature for customized and prioritized management. For example, an 80% likelihood is perhaps acceptable for social media traffic with strong periodicity for de-prioritization, whereas there should be a 90% likelihood for traffic generated by certain other apps, such as streaming apps. Conventional solutions, in contrast, merely produce yes/no universal resource locator (URL) lists (whether periodic, or occurred while screen off) with limited options to segment and prioritize.

As mentioned, the disclosed embodiments utilize existing browsing histories without implicating user-side access, which can be intrusive. The disclosed embodiments also do not implicate extensive manual annotation or testing, which can be expensive. Further, the disclosed embodiments are easy to customize, custom labeling functions can be constructed or added with the disclosed embodiments, and custom consolidation methods and learning models can be selected with the disclosed embodiments. Further, the various embodiments can be adapted to different cellular browsing data from any country generated by a wide range of UEs. Further, the disclosed embodiments are easy to update and provide interpretable output, providing a list of domains ranked in how likely they are to be background traffic.

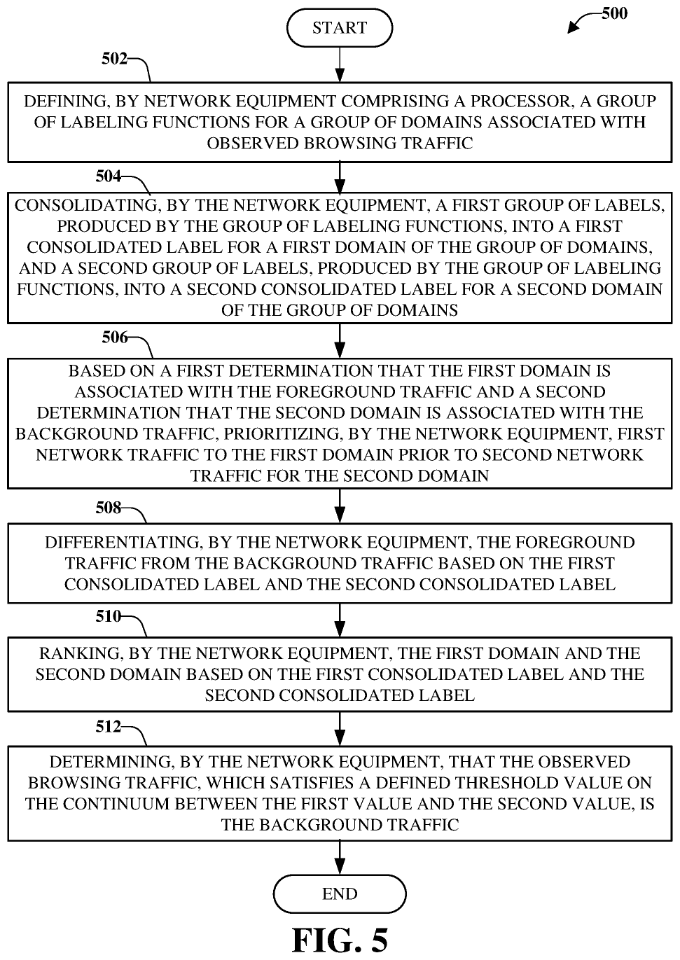

FIG. 5 illustrates an example, non-limiting, computer-implemented method 500 that facilitates identification of background browsing traffic in user browsing history data in advanced networks in accordance with one or more embodiments described herein. The computer-implemented method 500 can be implemented by a system including a processor, network equipment including a processor, or another computer-implemented device including a processor.

One or more of the various embodiments provided herein are directed to distinguishing between two types of traffic in browsing history (e.g., mobile browsing or other computer-implemented browsing). A first type of traffic is referred to as foreground traffic and the second type of traffic is referred to as background traffic. The foreground traffic occurs when the user or operator (referred to as user herein) of the UE is actively engaged with the UE. For example, the user can be performing tasks such as checking emails, engaging with an application executing on the UE, listening to audio, watching a video, speaking in a conference, and so on. The background traffic occurs when the user is not actively engaging with the UE. For example, when the UE is inactive, when the UE is not at a same physical location as the user, potentially when the screen is dark (but not necessarily when the screen is dark) and not being actively engaged with by a user. It is noted that there are situations when the screen is dark and the situations are still considered to be foreground traffic as discussed herein.

At 502, of the computer-implemented method 500, network equipment including a processor can define a group of labeling functions for a group of domains associated with observed browsing traffic. A labeling function is a function that labels any given domain (e.g., the traffic domain, the mobile traffic domain) as either background traffic, foreground traffic, somewhere in between background traffic and foreground traffic, or undefined (e.g., it cannot be determined whether it is foreground traffic or background traffic). According to some implementations, defining the group of labeling functions can include constructing the group of labeling functions to satisfy a defined accuracy level. Alternatively, or additionally, defining the group of labeling functions can include constructing the group of labeling functions to satisfy a defined coverage level.

The labeling functions can be in different classes. For example, a class can be centered on a screen off indicator and/or a screen on indicator (screen on/off indicator). In various embodiments, modifications or adjustments can be made to compensate for events occurring with respect to the UE that are independent of, but related to, the screen on/off indicator. An adjustment can include boundary time of the screen on/off indicator. Another adjustment to the screen on/off indicator can be related to when a user is finished engaging with the UE, the user does not turn off the screen, which enters standby (or idle) mode.

Another class of labeling functions is centered on the activity of the user. This can be related to a time of day (e.g., in the particular time zone activity at night is considered to be background because most users are sleeping). However, a user might be active during the night and, therefore, specific details related to the habits of the user can be considered, for example, from a user profile. In another example, a byte activity of the UE can be utilized to determine whether a given activity is more likely to be foreground traffic or more likely to be background traffic.

Yet another class of labeling functions is based on corrections for various activities including, for example, audio and/or video streaming, call conferencing, voice activated services, tethering, and so on. For example, a list or data structure can be utilized to capture and record the explicit domain or content delivery network (CDN) of these applications and/or services. When a domain with which the UE is interacting is included on the list (e.g., there is a match), the activity can be determined to be foreground traffic.

Another class of labeling functions can be based on periodicity of traffic, with modifications based on the frequency and intervals of appearance of the traffic. For example, it has been observed that background traffic is likely to occur at regular intervals and somewhat consistently. Alternatively, foreground traffic is more likely to occur in short spurts of a large number of requests.

Further, interarrival times (e.g., gaps between two successive visits to a domain) can be tracked to determine whether the traffic is foreground traffic or background traffic. For instance, if the interarrival times have a fairly large median (or mean or mode) and a small interquartile range (or standard deviation), traffic to the domain can be labeled as background traffic.

Yet another class of labels includes substring detection. Thus, words can provide clues whether the traffic should be labeled as foreground traffic or background traffic. For example, words such as “configuration,” “android,” “connectivity check,” and numerous other words can be compiled in one or more updatable and configurable lists. If there is a match in the substring, the traffic can be labeled as the foreground traffic. Another class of labeling functions can be based on intermediate output of an unsupervised learning, such as clustering or embeddings.

With continuing reference to FIG. 5, at 504 of the computer-implemented method 500, the network equipment can consolidate a first group of labels, produced by the group of labeling functions, into a first consolidated label for a first domain of the group of domains, and a second group of labels, produced by the group of labeling functions, into a second consolidated label for a second domain of the group of domains. The first consolidated label and the second consolidated label fall on a continuum between a first value indicative of the observed browsing traffic being foreground traffic and a second value indicative of the observed browsing traffic being background traffic. In some implementations, the consolidation can be based on a mode (e.g., a majority vote, an average, or a weighted average), a belief-propagation style iterative process, and/or a label consolidating process.

At 506, the network equipment can, based on a first determination that the first domain is associated with the foreground traffic and a second determination that the second domain is associated with the background traffic, prioritize first network traffic to the first domain prior to second network traffic for the second domain. For example, the first network traffic (labeled as foreground traffic) can be prioritized before the second network traffic (labeled on a continuum between foreground traffic and network traffic). Further, the second network traffic can be prioritized before third network traffic (labeled as background traffic).

The computer-implemented method 500 can continue, at 508, when the network equipment differentiates the foreground traffic from the background traffic based on the first consolidated label and the second consolidated label. Further, at 510, the network equipment can rank the first domain and the second domain based on the first consolidated label and the second consolidated label. Thereafter, at 512, the network equipment can determine that the observed browsing traffic, which satisfies a defined threshold value on the continuum between the first value and the second value, is the background traffic.

According to some implementations, the foreground traffic includes first information related to first browsing behavior that resulted from input via a user interface to a browser. Further to these implementations, the background traffic includes second information related to second browsing behavior that is not the result of the input.

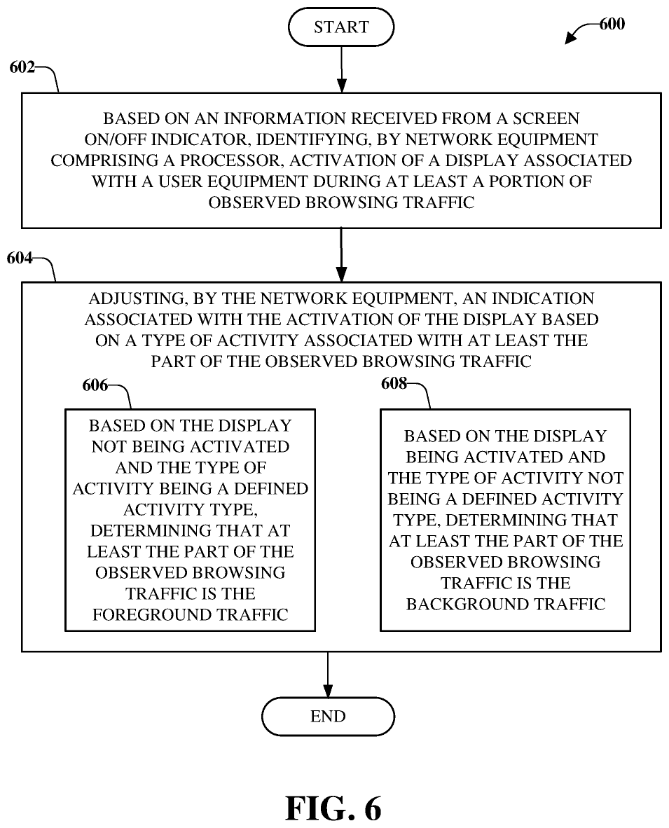

FIG. 6 illustrates an example, non-limiting, computer-implemented method 600 that facilitates determining status of traffic as background or foreground traffic based on information centered on a screen on and/or off indicator in accordance with one or more embodiments described herein. The computer-implemented method 600 can be implemented by a system including a processor, network equipment including a processor, or another computer-implemented device including a processor.

Based on information received from a screen on/off indicator, network equipment identifies, at 602, activation of a display associated with a user equipment during at least a portion (e.g., a time frame) of observed browsing traffic. Thus, in this case, the information from the screen on/off indicator indicates that the display is on. Accordingly, at 604, an indication associated with the activation of the display is adjusted based on a type of activity associated with at least the part of the observed browsing traffic.

In some implementations, the adjustment at 604 can include, based on the display not being activated and the type of activity being a defined activity type, determining that at least part of the observed browsing traffic is the foreground traffic, at 606. Alternatively, or additionally, the adjustment at 604 can include, based on the display being activated and the type of activity not being a defined activity type, determining that at least part of the observed browsing traffic is the background traffic, at 608.

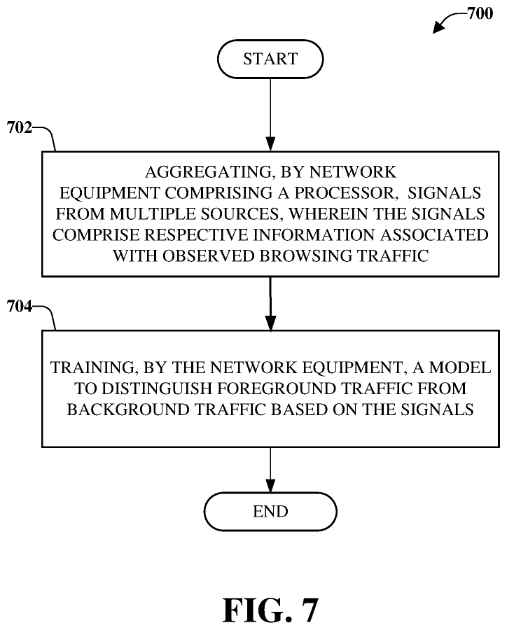

FIG. 7 illustrates an example, non-limiting, computer-implemented method 700 that builds a machine learning model based on labels consolidated from constructed label functions in accordance with one or more embodiments described herein. The computer-implemented method 700 can be implemented by a system including a processor, network equipment including a processor, or another computer-implemented device including a processor.

At 702, signals from multiple sources can be aggregated. The signals can include respective information associated with the observed browsing traffic. According to some implementations, the respective information includes a nature or characteristic of the observed browsing traffic. The nature or characteristic includes at least one of: a periodicity of the observed browsing traffic, intervals of the observed browsing traffic, a first number of upload bytes of the observed browsing traffic, a second number of download bytes of the observed browsing traffic, and frequency of the observed browsing traffic. In alternative or additional implementations, the respective information includes information related to a substring match of the observed browsing traffic.

A model can be trained, at 704, to distinguish the foreground traffic from the background traffic based on the signals. Advantages of performing this additional learning and prediction (e.g., building a machine learning model) include, but are not limited to, labeling with more accuracy and/or labeling new domains. As the learning and prediction relates to labeling with more accuracy, the labeling can be restricted to labeling functions that can label a large number of domains with reasonable accuracy. Accordingly, there should be a number of judgments or rules (e.g., the thresholds for frequency of appearances and numbers of upload/download bytes). The machine learning model can take in additional weaker or uncertain features at finer granularity and any features in raw values without thresholding. Given that the labels that have been trained are mostly or usually correct, the predictive model can learn defining patterns of background traffic, and can be more flexible in applying different levels of features to different sub-populations in different ways. Doing so provides more accurate predictions for all domains, especially for those with small numbers of labels from labeling functions.

As it relates to labeling new domains, domain spaces evolve over time and new domains, previously unseen, can be encountered. While labels can (and should be) periodically regenerated from all labeling functions and these labels can be reconsolidated, the trained machine learning model can be used to generate a prediction for the new domains instantly (or relatively quickly), and likely more accurately, as existing labeling functions may not generate many labels for new domains.

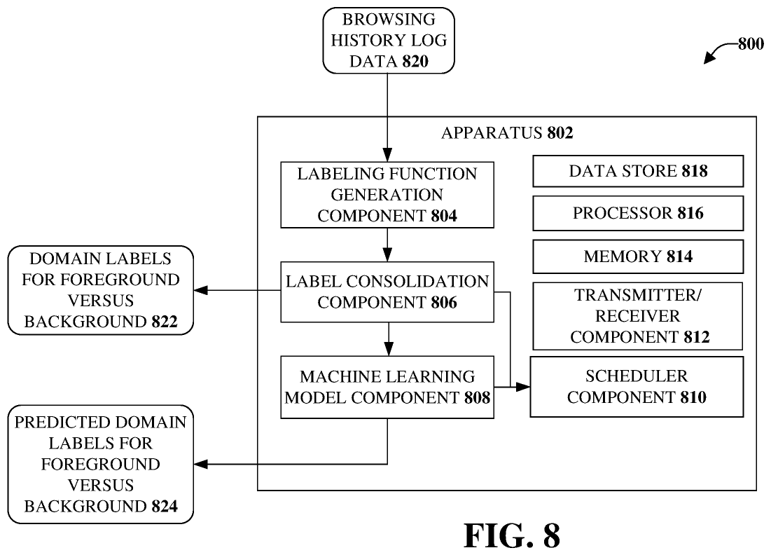

FIG. 8 illustrates an example, non-limiting, system 800 that facilitates identification of background browsing traffic in user browsing history data in advanced networks in accordance with one or more embodiments described herein. Repetitive description of like elements employed in other embodiments described herein is omitted for sake of brevity. The system 800 can include one or more of the components and/or functionality of the computer-implemented methods, and vice versa.

The system 800 can include an apparatus 802, which can be, or can be associated with, network equipment. The apparatus 802 can include a labeling function generation component 804, a label consolidation component 806, a machine learning model component 808, a scheduler component 810, a transmitter/receiver component 812, at least one memory 814, at least one processor 816, and at least one data store 818.

Aspects of systems (e.g., the system 800 and the like), apparatuses (e.g., the apparatus 802), or processes (e.g., computer-implemented methods) explained in this disclosure can include machine-executable component(s) embodied within machine(s) (e.g., embodied in one or more computer readable mediums (or media) associated with one or more machines). Such component(s), when executed by the one or more machines (e.g., computer(s), computing device(s), virtual machine(s), and so on) can cause the machine(s) to perform the operations described.

In various embodiments, the apparatus 802 can be any type of component, machine, device, facility, apparatus, and/or instrument that includes a processor and/or can be capable of effective and/or operative communication with a wired and/or wireless network. Components, machines, network equipment, user equipment, devices, facilities, and/or instrumentalities that can include the apparatus 802 can include tablet computing devices, handheld devices, server class computing machines and/or databases, laptop computers, notebook computers, desktop computers, cell phones, smart phones, consumer appliances and/or instrumentation, industrial and/or commercial devices, hand-held devices, digital assistants, multimedia Internet enabled phones, multimedia players, heretofore non-commercialized or concept devices (e.g., Internet Protocol (IP) aware contact lenses), and the like.

The system 800 can combine many sources of intelligence to determine whether the traffic is foreground or background traffic. Accordingly, aggregation of several different sources of intelligence can be made in order to determine whether a particular traffic is background or foreground traffic.

The labeling function generation component 804 can receive (e.g., via the transmitter/receiver component 812) browsing history log data 820. The browsing history log data 820 can be for a certain interval of time and/or for certain devices. Based, at least in part on the browsing history log data 820, the labeling function generation component 804 can construct labeling functions, such as, for example, discussed with respect to the computer-implemented method 100, the computer-implemented method 200, the computer-implemented method 500, the computer-implemented method 600, and/or other computer-implemented methods discussed herein.

The label consolidation component 806 can obtain the labels from the labeling function generation component 804. The label consolidation component 806 can consolidate the labels, such as, for example, discussed with respect to the computer-implemented method 100, the computer-implemented method 300, and/or other computer-implemented methods discussed herein.

The consolidated labels are output by the label consolidation component 806 as domain labels for background versus foreground 822. Optionally, the domain labels can be output from the label consolidation component 806 to the machine learning model component 808. The machine learning model component 808 can aggregate signals from multiple sources and train a model to distinguish the foreground traffic from the background traffic based on the signals, such as, for example, discussed with respect to the computer-implemented method 100, the computer-implemented method 400, the computer-implemented method 700, and/or other computer-implemented methods discussed herein. The output of the machine learning model component 808 can be predicted domain labels for background versus foreground 824. The machine learning model component 808 can provide an improvement and can build another model on top of the output from the label consolidation component 806.

The scheduler component 810 can receive, as input, an output of the label consolidation component 806 and/or an output of the machine learning model component 808. The scheduler component 810 can prioritize traffic labeled as foreground traffic before other traffic (e.g., traffic labeled between foreground traffic and background traffic, and traffic labeled as background traffic). For example, the scheduler component 810 can facilitate a first transmission of first network traffic assigned to labels indicative of the foreground traffic prior to a second transmission of second network traffic assigned to the labels indicative of traffic on a scale between foreground traffic, which is prioritized prior to a third transmission of third traffic assigned to the labels indicative of the background traffic.

According to some implementations, the scheduler component 810 can increase a first priority for scheduling first network traffic defined as the foreground traffic. Further, the scheduler component 810 can reduce a second priority for scheduling second network traffic defined as the background traffic.

With continuing reference to FIG. 8, the transmitter/receiver component 812 can receive, from user equipment (not shown), network equipment (not shown), another apparatus (not shown), and/or another system (not shown) one or more parameters that can be utilized as input data, one or more network considerations (e.g., capacity driven information, coverage driven information, and so on) in order to analyze one or more domains and determine whether the traffic for that domain is foreground traffic or background traffic.

The at least one memory 814 can be operatively connected to the at least one processor 816. The at least one memory 814 can store executable instructions that, when executed by the at least one processor 816 can facilitate performance of operations. Further, the at least one processor 816 can be utilized to execute computer executable components stored in the at least one memory 814.

For example, the at least one memory 814 can store protocols associated with facilitating identification of background browsing traffic in user browsing history data in advanced networks as discussed herein. Further, the at least one memory 814 can facilitate action to control communication between the apparatus 802, other apparatuses, other systems, and/or user equipment and/or network equipment associated with the network(s) under consideration, and so on, such that the apparatus 802 can employ stored protocols and/or process to facilitate identifying background browsing traffic in advanced networks as described herein.

It should be appreciated that data stores (e.g., memories) components described herein can be either volatile memory or nonvolatile memory, or can include both volatile and nonvolatile memory. By way of example and not limitation, nonvolatile memory can include read only memory (ROM), programmable ROM (PROM), electrically Programmable ROM (EPROM), Electrically Erasable ROM (EEPROM), or flash memory. Volatile memory can include Random Access Memory (RAM), which acts as external cache memory. By way of example and not limitation, RAM is available in many forms such as Synchronous RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), and Direct Rambus RAM (DRRAM). Memory of the disclosed aspects are intended to include, without being limited to, these and other suitable types of memory.

The at least one processor 816 can facilitate respective analysis of information related to identifying background browsing traffic and foreground browsing traffic in advanced networks. The at least one processor 816 can be a processor dedicated to analyzing and/or generating information received, a processor that controls one or more components of the apparatus 802, and/or a processor that both analyzes and generates information received and controls one or more components of the apparatus 802.

The machine learning model component 808, in connection with identifying background traffic and foreground traffic, can employ various artificial intelligence-based procedures for carrying out various aspects thereof. For example, a process for determining if a particular traffic is background traffic based on various criteria and/or information associated with the traffic can be enabled through an automatic classifier system and process.

A classifier is a function that maps an input attribute vector, x=(x1, x2, x3, x4, xn), to a confidence that the input belongs to a class. In other words, f(x)=confidence(class). Such classification can employ a probabilistic and/or statistical-based analysis (e.g., factoring into the analysis utilities and costs) to provide a prognosis and/or infer one or more actions that should be employed to determine how to label traffic to be automatically performed.

A Support Vector Machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that can be similar, but not necessarily identical to training data. Other directed and undirected model classification approaches (e.g., naïve Bayes, Bayesian networks, decision trees, neural networks, fuzzy logic models, and probabilistic classification models) providing different patterns of independence can be employed. Classification as used herein, can be inclusive of statistical regression that is utilized to develop models of priority.

One or more aspects can employ classifiers that are explicitly trained (e.g., through a generic training data) as well as classifiers that are implicitly trained (e.g., by observing UE behavior, by receiving extrinsic information, and so on). For example, SVMs can be configured through a learning or training phase within a classifier constructor and feature selection module. Thus, a classifier(s) can be used to automatically learn and perform a number of functions, including but not limited to determining, according to a predetermined criterion, when to label traffic as background traffic, when to label traffic as foreground traffic, labeling with more accuracy, labeling new domains, and so on.

Additionally, or alternatively, an implementation procedure (e.g., a rule, a policy, and so on) can be applied to label traffic as background traffic or foreground traffic to a defined level of confidence. In some implementations, based upon a predefined criterion, the rules-based implementation can automatically and/or dynamically analyze traffic and/or associated domains. In response thereto, the rule-based implementation can automatically interpret and carry out functions associated with the traffic and/or associated domains by employing a predefined and/or programmed rule(s) based upon any desired criteria.

As discussed herein, determining whether traffic is foreground traffic (e.g., a user is engaged with the traffic) versus background traffic (e.g., a user is not engaged with the traffic) facilitates prioritization or de-prioritization of traffic during network management. Accordingly, background traffic (which represents a large amount of traffic) can be de-prioritized without a negative impact to the user experience. For example, the traffic when an operating system is updating generally is non-user intended and is background traffic because it usually occurs when a user is not engaged with the device and, in most cases, the user did not request the update. Background traffic can also be user intended such as, for example, a large movie download. The movie was requested by the user to be downloaded and is to be considered user intended, but it is occurring in the background (e.g., the user is not waiting for the download). Alternatively, the foreground also can be non-user intended, for example, third party requests when the user enters a domain name the user is actively engaged, but the advertisements and social media being opened are not intended by the user. Accordingly, the disclosed embodiments can identify such use cases and identify the traffic, regardless of a status of a screen on/off indicator.

The disclosed embodiments allow for segmentation and ranking of background traffic for customized and prioritized management, by providing accuracy and confidence measures of how likely traffic is background, and providing indications of the different types, signatures, or segments to which each background traffic belongs. Further, the disclosed embodiments utilize existing browsing histories without needing user side access, or extensive annotation and/or testing. Additionally, the disclosed embodiments are easy to customize, update, and interpret.

Further the disclosed embodiments provide telecommunication companies with the ability to identify background traffic and separate such traffic from foreground traffic. Foreground traffic can be prioritized, and/or background traffic can be de-prioritized to a customizable extent. Telecommunication businesses could monitor and manage background traffic separately from foreground traffic in any way desired. As mobile internet usage increases rapidly in the coming years, in the U.S. and even more so in some other countries in Asia, Latin America, Middle East, and Africa, more telecommunication businesses will come to value the ability to detect and separate background from foreground traffic for optimal network management as discussed herein.

Methods that can be implemented in accordance with the disclosed subject matter, will be better appreciated with reference to the above flow charts. While, for purposes of simplicity of explanation, the methods are shown and described as a series of blocks, it is to be understood and appreciated that the disclosed aspects are not limited by the number or order of blocks, as some blocks can occur in different orders and/or at substantially the same time with other blocks from what is depicted and described herein. Moreover, not all illustrated blocks can be required to implement the disclosed methods. It is to be appreciated that the functionality associated with the blocks can be implemented by software, hardware, a combination thereof, or any other suitable means (e.g. device, system, process, component, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

Described herein are systems, methods, articles of manufacture, and other embodiments or implementations that can facilitate identification of background browsing traffic in user browsing history data for advanced networks. Facilitating identification of background browsing traffic in user browsing history data for advanced networks can be implemented in connection with any type of device with a connection to the communications network (e.g., a mobile handset, a computer, a handheld device, etc.) any Internet of things (IoT) device (e.g., toaster, coffee maker, blinds, music players, speakers, etc.), and/or any connected vehicles (cars, airplanes, space rockets, and/or other at least partially automated vehicles (e.g., drones)). In some embodiments, the non-limiting term User Equipment (UE) is used. It can refer to any type of wireless device that communicates with a radio network node in a cellular or mobile communication system. Examples of UE are target device, device to device (D2D) UE, machine type UE or UE capable of machine to machine (M2M) communication, PDA, Tablet, mobile terminals, smart phone, Laptop Embedded Equipped (LEE), laptop mounted equipment (LME), USB dongles etc. Note that the terms element, elements and antenna ports can be interchangeably used but carry the same meaning in this disclosure. The embodiments are applicable to single carrier as well as to Multi-Carrier (MC) or Carrier Aggregation (CA) operation of the UE. The term Carrier Aggregation (CA) is also called (e.g., interchangeably called) “multi-carrier system,” “multi-cell operation,” “multi-carrier operation,” “multi-carrier” transmission and/or reception.

The term network equipment is used herein to refer to any type of network node serving UE and/or connected to other network equipment, network nodes, network elements, or another network node from which the UEs can receive a radio signal. In cellular radio access networks (e.g., Universal Mobile Telecommunications System (UMTS) networks), network nodes can be referred to as base transceiver stations (BTS), radio base station, radio network nodes, base stations, NodeB, eNodeB (e.g., evolved NodeB), and so on. In 5G terminology, the network nodes can be referred to as gNodeB (e.g., gNB) devices. Network nodes can also include multiple antennas for performing various transmission operations (e.g., MIMO operations). A network node can include a cabinet and other protected enclosures, an antenna mast, and actual antennas. Network nodes can serve several cells, also called sectors, depending on the configuration and type of antenna. Examples of network nodes can include but are not limited to: NodeB devices, base station (BS) devices, access point (AP) devices, and radio access network (RAN) devices. The network nodes can also include Multi-Standard Radio (MSR) radio node devices, comprising: an MSR BS, an eNode B, a network controller, a Radio Network Controller (RNC), Base Station Controller (BSC), a relay, a donor node controlling relay, a Base Transceiver Station (BTS), an Access Point (AP), a transmission point, a transmission node, a Remote Radio Unit (RRU), a Remote Radio Head (RRH), nodes in distributed antenna system (DAS), and the like.

In some embodiments, the non-limiting term radio network node or simply network node is used. It can refer to any type of network node that serves one or more UEs and/or that is coupled to other network nodes or network elements or any radio node from where the one or more UEs receive a signal. Examples of radio network nodes are Node B, Base Station (BS), Multi-Standard Radio (MSR) node such as MSR BS, eNode B, network controller, Radio Network Controller (RNC), Base Station Controller (BSC), relay, donor node controlling relay, Base Transceiver Station (BTS), Access Point (AP), transmission points, transmission nodes, RRU, RRH, nodes in Distributed Antenna System (DAS) etc.

Cloud Radio Access Networks (RAN) can enable the implementation of concepts such as Software-Defined Network (SDN) and Network Function Virtualization (NFV) in 5G networks. This disclosure can facilitate a generic channel state information framework design for a 5G network. Certain embodiments of this disclosure can include an SDN controller that can control routing of traffic within the network and between the network and traffic destinations. The SDN controller can be merged with the 5G network architecture to enable service deliveries via open Application Programming Interfaces (APIs) and move the network core towards an all Internet Protocol (IP), cloud based, and software driven telecommunications network. The SDN controller can work with, or take the place of Policy and Charging Rules Function (PCRF) network elements so that policies such as quality of service and traffic management and routing can be synchronized and managed end to end.

To meet the huge demand for data centric applications, 4G standards can be applied to 5G, also called New Radio (NR) access. 5G networks can include the following: data rates of several tens of megabits per second supported for tens of thousands of users; 1 gigabit per second can be offered simultaneously (or concurrently) to tens of workers on the same office floor; several hundreds of thousands of simultaneous (or concurrent) connections can be supported for massive sensor deployments; spectral efficiency can be enhanced compared to 4G; improved coverage; enhanced signaling efficiency; and reduced latency compared to LTE. In multicarrier system such as OFDM, each subcarrier can occupy bandwidth (e.g., subcarrier spacing). If the carriers use the same bandwidth spacing, then it can be considered a single numerology. However, if the carriers occupy different bandwidth and/or spacing, then it can be considered a multiple numerology.

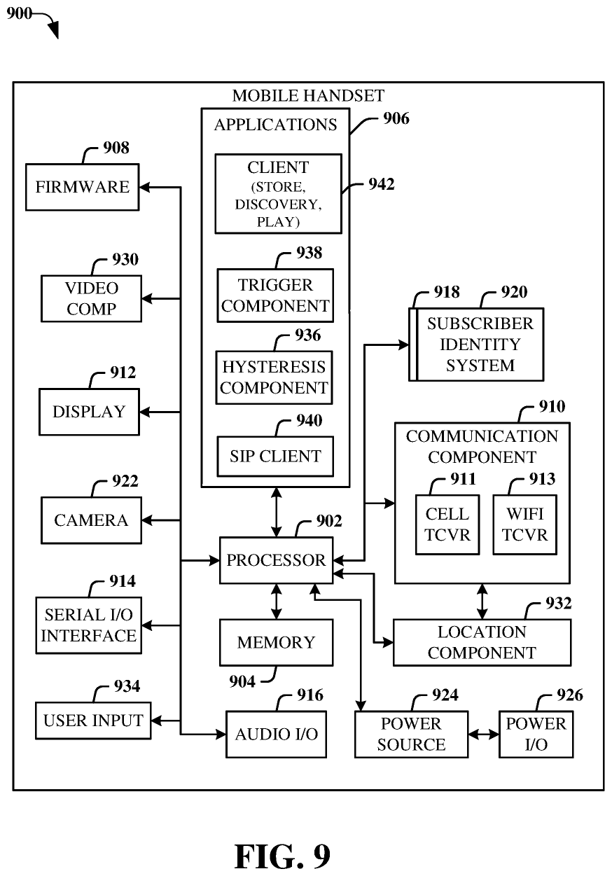

Referring now to FIG. 9, illustrated is an example, non-limiting, block diagram of a handset 900 operable to engage in a system architecture that facilitates wireless communications according to one or more embodiments described herein. Although a mobile handset is illustrated herein, it will be understood that other devices can be a mobile device, and that the mobile handset is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset includes a processor 902 for controlling and processing all onboard operations and functions. A memory 904 interfaces to the processor 902 for storage of data and one or more applications 906 (e.g., a video player software, user feedback component software, etc.). Other applications can include voice recognition of predetermined voice commands that facilitate initiation of the user feedback signals. The applications 906 can be stored in the memory 904 and/or in a firmware 908, and executed by the processor 902 from either or both the memory 904 or/and the firmware 908. The firmware 908 can also store startup code for execution in initializing the handset 900. A communications component 910 interfaces to the processor 902 to facilitate wired/wireless communication with external systems, e.g., cellular networks, VoIP networks, and so on. Here, the communications component 910 can also include a suitable cellular transceiver 911 (e.g., a GSM transceiver) and/or an unlicensed transceiver 913 (e.g., Wi-Fi, WiMax) for corresponding signal communications. The handset 900 can be a device such as a cellular telephone, a PDA with mobile communications capabilities, and messaging-centric devices. The communications component 910 also facilitates communications reception from terrestrial radio networks (e.g., broadcast), digital satellite radio networks, and Internet-based radio services networks.

The handset 900 includes a display 912 for displaying text, images, video, telephony functions (e.g., a Caller ID function), setup functions, and for user input. For example, the display 912 can also be referred to as a “screen” that can accommodate the presentation of multimedia content (e.g., music metadata, messages, wallpaper, graphics, etc.). The display 912 can also display videos and can facilitate the generation, editing and sharing of video quotes. A serial I/O interface 914 is provided in communication with the processor 902 to facilitate wired and/or wireless serial communications (e.g., USB, and/or IEEE 1394) through a hardwire connection, and other serial input devices (e.g., a keyboard, keypad, and mouse). This supports updating and troubleshooting the handset 900, for example. Audio capabilities are provided with an audio I/O component 916, which can include a speaker for the output of audio signals related to, for example, indication that the user pressed the proper key or key combination to initiate the user feedback signal. The audio I/O component 916 also facilitates the input of audio signals through a microphone to record data and/or telephony voice data, and for inputting voice signals for telephone conversations.

The handset 900 can include a slot interface 918 for accommodating a SIC (Subscriber Identity Component) in the form factor of a card Subscriber Identity Module (SIM) or universal SIM 920, and interfacing the SIM card 920 with the processor 902. However, it is to be appreciated that the SIM card 920 can be manufactured into the handset 900, and updated by downloading data and software.

The handset 900 can process IP data traffic through the communications component 910 to accommodate IP traffic from an IP network such as, for example, the Internet, a corporate intranet, a home network, a person area network, etc., through an ISP or broadband cable provider. Thus, VoIP traffic can be utilized by the handset 900 and IP-based multimedia content can be received in either an encoded or decoded format.

A video processing component 922 (e.g., a camera) can be provided for decoding encoded multimedia content. The video processing component 922 can aid in facilitating the generation, editing, and sharing of video quotes. The handset 900 also includes a power source 924 in the form of batteries and/or an AC power subsystem, which power source 924 can interface to an external power system or charging equipment (not shown) by a power 110 component 926.

The handset 900 can also include a video component 930 for processing video content received and, for recording and transmitting video content. For example, the video component 930 can facilitate the generation, editing and sharing of video quotes. A location tracking component 932 facilitates geographically locating the handset 900. As described hereinabove, this can occur when the user initiates the feedback signal automatically or manually. A user input component 934 facilitates the user initiating the quality feedback signal. The user input component 934 can also facilitate the generation, editing and sharing of video quotes. The user input component 934 can include such conventional input device technologies such as a keypad, keyboard, mouse, stylus pen, and/or touchscreen, for example.

Referring again to the applications 906, a hysteresis component 936 facilitates the analysis and processing of hysteresis data, which is utilized to determine when to associate with the access point. A software trigger component 938 can be provided that facilitates triggering of the hysteresis component 936 when the Wi-Fi transceiver 913 detects the beacon of the access point. A SIP client 940 enables the handset 900 to support SIP protocols and register the subscriber with the SIP registrar server. The applications 906 can also include a client 942 that provides at least the capability of discovery, play and store of multimedia content, for example, music.

The handset 900, as indicated above related to the communications component 910, includes an indoor network radio transceiver 913 (e.g., Wi-Fi transceiver). This function supports the indoor radio link, such as IEEE 802.11, for a dual-mode GSM handset. The handset 900 can accommodate at least satellite radio services through a handset that can combine wireless voice and digital radio chipsets into a single handheld device.

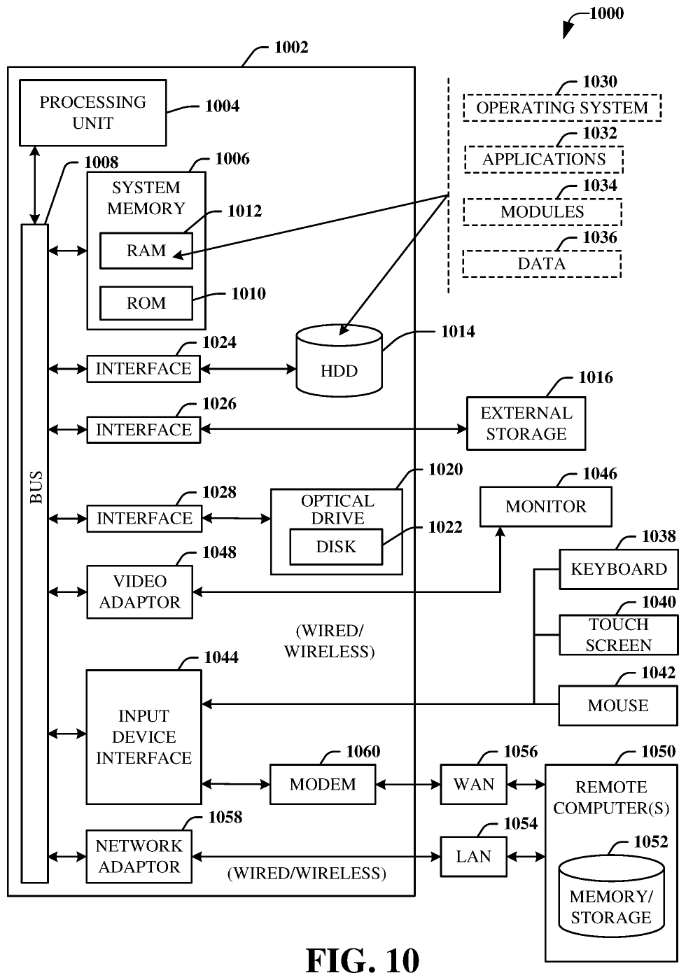

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A Basic Input/Output System (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and a drive 1020, e.g., such as a solid state drive, an optical disk drive, which can read or write from a disk 1022, such as a CD-ROM disc, a DVD, a BD, etc. Alternatively, where a solid state drive is involved, disk 1022 would not be included, unless separate. While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and drive 1020 can be connected to the system bus 1008 by an HDD interface 1024, an external storage interface 1026 and a drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above, such as but not limited to a network virtual machine providing one or more aspects of storage or processing of information. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

An aspect of 5G, which differentiates from previous 4G systems, is the use of NR. NR architecture can be designed to support multiple deployment cases for independent configuration of resources used for RACH procedures. Since the NR can provide additional services than those provided by LTE, efficiencies can be generated by leveraging the pros and cons of LTE and NR to facilitate the interplay between LTE and NR, as discussed herein.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” and the like are intended to refer to, or include, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “mobile device equipment,” “mobile station,” “mobile,” subscriber station,” “access terminal,” “terminal,” “handset,” “communication device,” “mobile device,” “user equipment” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “Node B (NB),” “evolved Node B (eNode B),” “home Node B (HNB)” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

The various aspects described herein can relate to New Radio (NR), which can be deployed as a standalone radio access technology or as a non-standalone radio access technology assisted by another radio access technology, such as Long Term Evolution (LTE), for example. It should be noted that although various aspects and embodiments have been described herein in the context of 5G, Universal Mobile Telecommunications System (UMTS), and/or Long Term Evolution (LTE), or other next generation networks, the disclosed aspects are not limited to 5G, 6G, a UMTS implementation, and/or an LTE implementation as the techniques can also be applied in 3G, 4G, or LTE systems. For example, aspects or features of the disclosed embodiments can be exploited in substantially any wireless communication technology. Such wireless communication technologies can include UMTS, Code Division Multiple Access (CDMA), Wi-Fi, Worldwide Interoperability for Microwave Access (WiMAX), General Packet Radio Service (GPRS), Enhanced GPRS, Third Generation Partnership Project (3GPP), LTE, Third Generation Partnership Project 2 (3GPP2) Ultra Mobile Broadband (UMB), High Speed Packet Access (HSPA), Evolved High Speed Packet Access (HSPA+), High-Speed Downlink Packet Access (HSDPA), High-Speed Uplink Packet Access (HSUPA), Zigbee, or another IEEE 802.XX technology. Additionally, substantially all aspects disclosed herein can be exploited in legacy telecommunication technologies.

As used herein, “5G” can also be referred to as NR access. Accordingly, systems, methods, and/or machine-readable storage media for facilitating link adaptation of downlink control channel for 5G systems are desired. As used herein, one or more aspects of a 5G network can include, but is not limited to, data rates of several tens of megabits per second (Mbps) supported for tens of thousands of users; at least one gigabit per second (Gbps) to be offered simultaneously to tens of users (e.g., tens of workers on the same office floor); several hundreds of thousands of simultaneous connections supported for massive sensor deployments; spectral efficiency significantly enhanced compared to 4G; improvement in coverage relative to 4G; signaling efficiency enhanced compared to 4G; and/or latency significantly reduced compared to LTE.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification procedures and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
defining, by network equipment comprising a processor, a group of labeling functions for a group of domains associated with observed browsing traffic;
consolidating, by the network equipment, a first group of labels, produced by the group of labeling functions, into a first consolidated label for a first domain of the group of domains, and a second group of labels, produced by the group of labeling functions, into a second consolidated label for a second domain of the group of domains, wherein the first consolidated label and the second consolidated label each lie on a continuum between a first value indicative of the observed browsing traffic being foreground traffic and a second value indicative of the observed browsing traffic being background traffic; and
based on a first determination that the first domain is associated with the foreground traffic and a second determination that the second domain is associated with the background traffic, prioritizing, by the network equipment, first network traffic to the first domain prior to second network traffic for the second domain.

2. The method of claim 1, further comprising:
differentiating, by the network equipment, the foreground traffic from the background traffic based on the first consolidated label and the second consolidated label.

3. The method of claim 2, further comprising:
ranking, by the network equipment, the first domain and the second domain based on the first consolidated label and the second consolidated label; and
determining, by the network equipment, that the observed browsing traffic, which satisfies a defined threshold value on the continuum between the first value and the second value, is the background traffic.

4. The method of claim 1, wherein the foreground traffic comprises first information related to first browsing behavior that resulted from input via a user interface to a browser, and wherein the background traffic comprises second information related to second browsing behavior that did not result from the input.

5. The method of claim 1, wherein the defining comprises:
identifying activation of a display associated with a user equipment during at least part of the observed browsing traffic; and
adjusting an indication associated with the activation of the display based on a type of activity associated with at least the part of the observed browsing traffic.

6. The method of claim 5, wherein the adjusting comprises:
based on the display not being activated and the type of activity being a defined activity type, determining that at least the part of the observed browsing traffic is the foreground traffic.

7. The method of claim 5, wherein the adjusting comprises, based on the display being activated and the type of activity not being a defined activity type, determining that at least the part of the observed browsing traffic is the background traffic.

8. The method of claim 1, wherein the defining comprises:
aggregating signals from multiple sources, wherein the signals comprise respective information associated with the observed browsing traffic, and wherein the aggregating results in aggregated signals; and
training a model to distinguish the foreground traffic from the background traffic based on the aggregated signals.

9. The method of claim 8, wherein the respective information comprises a first activity level of a user equipment for a first time period, and a second activity level of the user equipment for a second time period, and wherein the method further comprises:
based on the first activity level satisfying a defined activity level, classifying, by the network equipment, first browsing traffic occurring during the first time period as the foreground traffic; and
based on the second activity level satisfying the defined activity level, classifying, by the network equipment, second browsing traffic occurring during the second time period as the background traffic.

10. The method of claim 8, wherein the respective information comprises a data structure comprising known domains, and wherein the method further comprises:
mapping, by the network equipment, at least a subgroup of domains of the group of domains to the known domains; and
based on the mapping indicating that the first domain matches a known domain of the known domains in the data structure, classifying, by the network equipment, the first domain as the foreground traffic.

11. The method of claim 8, wherein the respective information comprises a characteristic of the observed browsing traffic, wherein the characteristic comprises at least one characteristic from a group of characteristics, comprising: a periodicity of the observed browsing traffic, intervals of the observed browsing traffic, a first amount of upload bytes of the observed browsing traffic, a second amount of download bytes of the observed browsing traffic, and a frequency of the observed browsing traffic.

12. The method of claim 8, wherein the respective information comprises a data structure that comprises defined substrings, and wherein the method further comprises:
matching, by the network equipment, a subgroup of substrings associated with a portion of the observed browsing traffic to the defined substrings; and
based on the matching indicating the subgroup of substrings matches a defined substring of the substrings, classifying, by the network equipment, the portion of the observed browsing traffic as the background traffic.

13. The method of claim 1, wherein the defining comprises partitioning the group of domains into clusters based on an unsupervised learning based clustering analysis of the group of domains.

14. A system, comprising:
a processor; and
a memory that stores executable instructions that, when executed by the processor, facilitate performance of operations, comprising:
based on browsing history traffic observed with respect to a group of user equipment, constructing labeling functions for a group of domains associated with the browsing history traffic;
producing a group of labels based on the labeling functions, wherein the group of labels are associated with a first domain of the group of domains;
transforming the group of labels into a single consolidated label for the first domain, wherein the single consolidated label is represented as a first numeric value that is on a continuum between two values, wherein the two values comprise a first value and a second value, wherein the first value is indicative of the browsing history traffic being foreground traffic, and wherein the second value is indicative of the browsing history traffic being background traffic; and
based on a determination that the first numeric value of the single consolidated label is nearer to the first value than the second value, scheduling first traffic for the first domain prior to scheduling traffic for a second domain determined to comprise a second numeric value that is nearer to the second value than the first value.

15. The system of claim 14, wherein the first value is 0 and the second value is 1, wherein the foreground traffic comprises first information related to first browsing behavior that is based on user input, and wherein the background traffic comprises second information related to second browsing behavior that is not based on the user input.

16. The system of claim 14, wherein the operations further comprise:
identifying domains of the group of domains that are associated with audio streaming, conference functions, or voice activated services, resulting in identified domains; and
labeling traffic determined to be associated with the identified domains as the foreground traffic.

17. The system of claim 14, wherein the operations further comprise:
identifying domains of the group of domains that are associated with defined substrings, resulting in identified domains; and
labeling traffic determined to be associated with the identified domains as the background traffic.

18. A non-transitory machine-readable medium, comprising executable instructions that, when executed by a processor, facilitate performance of operations, comprising:
generating, based on a group of labeling functions established for domains accessed during a defined period of time and associated with observed browsing traffic, a first group of labels for a first domain of the domains and a second group of labels for a second domain of the domains;
consolidating the first group of labels into a first label for the first domain, and the second group of labels into a second label for the second domain, wherein the first label and the second label respectively fall on a continuum between a first state and a second state, wherein the first state is indicative of the observed browsing traffic being foreground traffic, and wherein the second state is indicative of the observed browsing traffic being background traffic;
based on first network traffic, determined to be intended for the first domain, being classified as the foreground traffic, increasing a first priority for scheduling the first network traffic; and
based on second network traffic, determined to be intended for the second domain, being classified as the background traffic, reducing a second priority for scheduling the second network traffic to be less than the first priority.

19. The non-transitory machine-readable medium of claim 18, wherein the foreground traffic comprises information related to user-engaged browsing behavior, and wherein the background traffic comprises background activity void of the information related to the user-engaged browsing behavior.

20. The non-transitory machine-readable medium of claim 18, wherein the operations further comprise:
detecting activation of a display associated with a user equipment during the observed browsing traffic; and
adjusting an indication associated with the activation of the display based on a type of activity associated with the observed browsing traffic, wherein the adjusting comprises:
based on the display not being activated and the type of activity being determined to be of a defined activity type, determining that the observed browsing traffic is the foreground traffic, and
based on the display being activated and the type of activity being determined not to be of the defined activity type, determining that the observed browsing traffic is the background traffic.
